(19) United States
(12) Patent Application Publication
(10) Pub. No.: US 2014/0020114 A1
(43) Pub. Date: Jan. 16, 2014

(54) METHODS AND APPARATUSES FOR INTEGRATING A PORTION OF SECURE ELEMENT COMPONENTS ON A SYSTEM ON CHIP

(71) Applicant: QUALCOMM Incorporated, San Diego, CA (US)

(72) Inventors: Neeraj Bhatia, San Francisco, CA (US); Jeremy O'Donoghue, Wokingham (GB)

(21) Appl. No.: 13/931,708

(22) Filed: Jun. 28, 2013

Related U.S. Application Data
(60) Provisional application No. 61/671,290, filed on Jul. 13, 2012.

(51) Int. Cl. G06F 21/62

(52) U.S. Cl. CPC G06F 21/62
USPC 726/27

(57) ABSTRACT

A method, an apparatus, and a computer program product for wireless communication are provided in connection with providing efficient SE functionality. In one example, a communications device includes a SE which includes a processor, RAM, and NVM, and secured and unsecured components. The SE may be equipped to receive a request to access a function that is accessible through information stored in the SE, retrieve a first portion of the information associated with the function that is stored in the secured component, obtain a second portion of the information associated with the function that is stored in the unsecured component, and facilitate access to the function using the first retrieved portion of the information to enable access to the second obtained portion of the information. In an aspect, the secured component may include the processor and the RAM, and the unsecured component may include substantially all of the NVM.

### CLAIM OF PRIORITY UNDER 35 U.S.C. §119

The present Application for Patent claims priority to Provisional Application No. 61/671,290 entitled “METHODS AND APPARATUSES FOR INTEGRATING A PORTION OF SECURE ELEMENT COMPONENTS ON A SYSTEM ON CHIP” filed Jul. 13, 2012, and assigned to the assignee hereof and hereby expressly incorporated by reference herein.

### BACKGROUND

1. Field

The disclosed aspects relate generally to communications between and/or within devices and specifically to methods and systems for using secure elements in which a portion of the secure element is integrated into a system on chip (SoC).

2. Background

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Many such cellular telephones are being manufactured with relatively large increases in computing capabilities, and as such, are becoming tantamount to small personal computers and hand-held PDAs. Further, such devices are being manufactured to enable communications using a variety of frequencies and applicable coverage areas, such as cellular communications, wireless local area network (WLAN) communications, near field communication (NFC), etc.

Currently, within a device some applications may be configured to use high levels of security, including protection against physical and/or software incursions. Such applications may be hosted in Secure Elements (SEs). As used herein, a SE may include a complete computing platform (e.g., random access memory (RAM), read only memory (ROM), non-volatile memory (NVM), cryptographic accelerators, central processing unit (CPU), etc.) which has been hardened to protect against unauthorized access. While these SEs may achieve very high levels of security, they may also be relatively costly when integrated into the device. For example, a SE is typically created using separate Silicon processes and, as such, may not benefit from the cost benefits possible on an integrated SoC.

Thus, improved methods and apparatuses for providing efficient SE functionality may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with providing efficient SE functionality. In one example, a communications device includes a SE which includes a processor, RAM, and NVM, a secured component, and an unsecured component. In an aspect, the unsecured component and the secured component are coupled through an interface. The SE may be equipped to receive a request to access a function that is accessible through information stored in the SE, retrieve a first portion of the information associated with the function that is stored in the secured component of the SE, obtain a second portion of the information associated with the function that is stored in the unsecured component of the SE, and facilitate access to the function using the first retrieved portion of the information to enable access to the second obtained portion of the information. In an aspect, the secured component may include the processor and the RAM, and the unsecured component may include substantially all of the NVM.

According to related aspects, a method for providing efficient SE functionality is provided. The method can include receiving a request to access a function that is accessible through information stored in the SE. In an aspect, the SE may include a processor, RAM, and NVM. Further, the method can include retrieving a first portion of the information associated with the function that is stored in a secured component of the SE. In an aspect, the secured component may include the processor and the RAM. Further, the method can include obtaining a second portion of the information associated with the function that is stored in an unsecured component of the SE. In an aspect, the unsecured component may include substantially all of the NVM. Moreover, the method may include facilitating access to the function using the first retrieved portion of the information to enable access to the second obtained portion of the information.

Another aspect relates to a communications apparatus enabled to provide efficient SE functionality. The communications apparatus can include means for receiving a request to access a function that is accessible through information stored in the SE. In an aspect, the SE may include a processor, RAM, and NVM. Further, the communications apparatus can include means for retrieving a first portion of the information associated with the function that is stored in a secured component of the SE. In an aspect, the secured component may include the processor and the RAM. Further, the communications apparatus can include means for obtaining a second portion of the information associated with the function that is stored in an unsecured component of the SE. In an aspect, the unsecured component may include substantially all of the NVM. Moreover, the communications apparatus can include means for facilitating access to the function using the first retrieved portion of the information to enable access to the second obtained portion of the information.

Another aspect relates to a communications apparatus. The apparatus may include a SE which includes a processor, RAM, and NVM, a secured component of the SE, and an unsecured component of the SE. The SE may be configured to receive a request to access a function that is accessible through information stored in the SE. Further, the SE may be configured to retrieve a first portion of the information associated with the function that is stored in a secured component of the SE. In an aspect, the secured component may include the processor and the RAM. Further, the SE may be configured to obtain a second portion of the information associated with the function that is stored in an unsecured component of the SE. In an aspect, the unsecured component may include substantially all of the NVM. Moreover, the SE may be configured to facilitate access to the function using the first retrieved portion of the information to enable access to the second obtained portion of the information.

Still another aspect relates to a computer program product, which can have a computer-readable medium including code for receiving a request to access a function that is accessible through information stored in the SE. In an aspect, the SE may include a processor, RAM, and NVM. Further, the computer-readable medium may include code for retrieving a first portion of the information associated with the function that is stored in a secured component of the SE. In an aspect, the secured component may include the processor and the RAM. Further, the computer-readable medium may include code for obtaining a second portion of the information associated with the function that is stored in an unsecured component of the SE. In an aspect, the unsecured component may include substantially all of the NVM. Moreover, the computer-readable medium can include code for facilitating access to the function using the first retrieved portion of the information to enable access to the second obtained portion of the information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a simplified block diagram of an induction based communication system, according to an aspect;

FIG. 2 is a simplified schematic diagram of an induction based system, according to an aspect;

FIG. 3 is a block diagram of a SoC with an integrated SE, according to an aspect;

FIG. 4 is a flowchart describing an example method for using an SE integrated into a SoC, according to an aspect;

FIG. 5 is a block diagram of aspects of a communications device according to the present disclosure; and

FIG. 6 illustrates a block diagram of an example a communications device for providing efficient SE functionality, according to an aspect.

### DETAILED DESCRIPTION

Various aspects are now described with reference to the drawings. In the following description, for purposes of explanation, numerous specific details are set forth to provide a thorough understanding of one or more aspects. It may be evident, however, that such aspect(s) may be practiced without these specific details.

Generally, a communications device may access various functionalities through use of a SE. The SE provides an environment to store information which has typically been hardened to protect against unauthorized access. Further, a SE may include various components, such as but not limited to, RAM, ROM, NV memory (NVM), cryptographic accelerators, CPU, etc. As described herein, a system architecture is presented in which one or more of the components of the SE may be separated and included (e.g., integrated) in a SoC. As such, levels of security comparable with conventional monolithic SE designs can be achieved using an integrated and lower cost architecture.

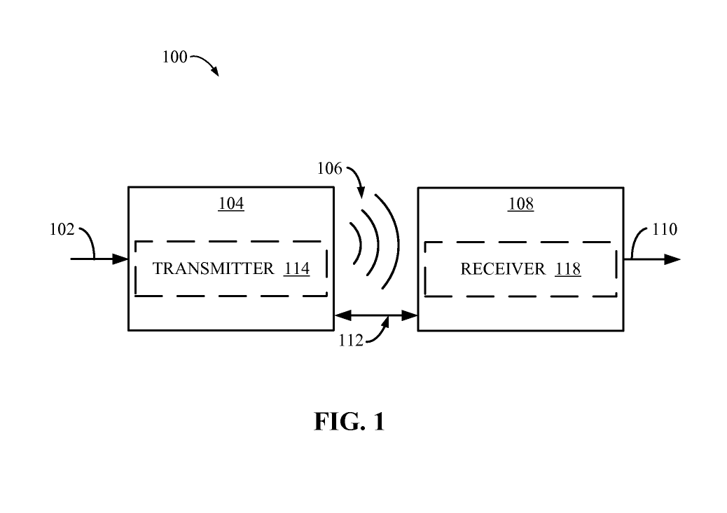

FIG. 1 illustrates an induction based communication system 100, in accordance with various exemplary embodiments of the present invention. Input power 102 is provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

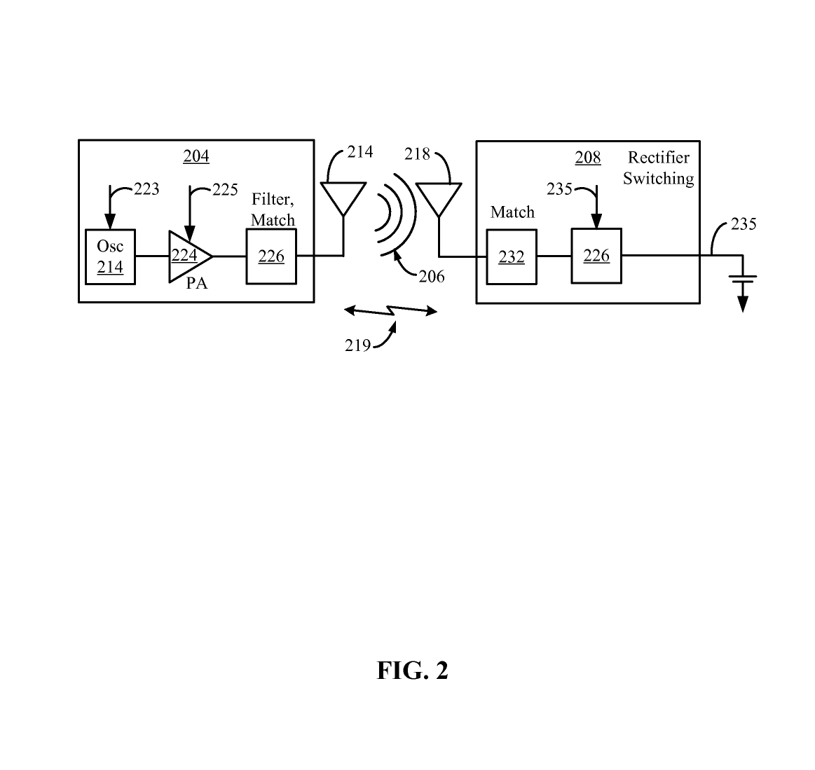

FIG. 2 shows a simplified schematic diagram of a near field induction based communications system. The transmitter 204 includes an oscillator 222, a power amplifier 224 and a filter and matching circuit 226. The oscillator is configured to generate a signal at a desired frequency, which may be adjusted in response to adjustment signal 223. The oscillator signal may be amplified by the power amplifier 224 with an amplification amount responsive to control signal 225. The filter and matching circuit 226 may be included to filter out harmonics or other unwanted frequencies and match the impedance of the transmitter 204 to the transmit antenna 214.

The receiver 208 may include a matching circuit 232 and a rectifier and switching circuit 234 to generate a DC power output to charge a battery 236 as shown in FIG. 2 or power a device coupled to the receiver (not shown). The matching circuit 232 may be included to match the impedance of the receiver 208 to the receive antenna 218. The receiver 208 and transmitter 204 may communicate on a separate communication channel 219 (e.g., Bluetooth, Zigbee, cellular, etc).

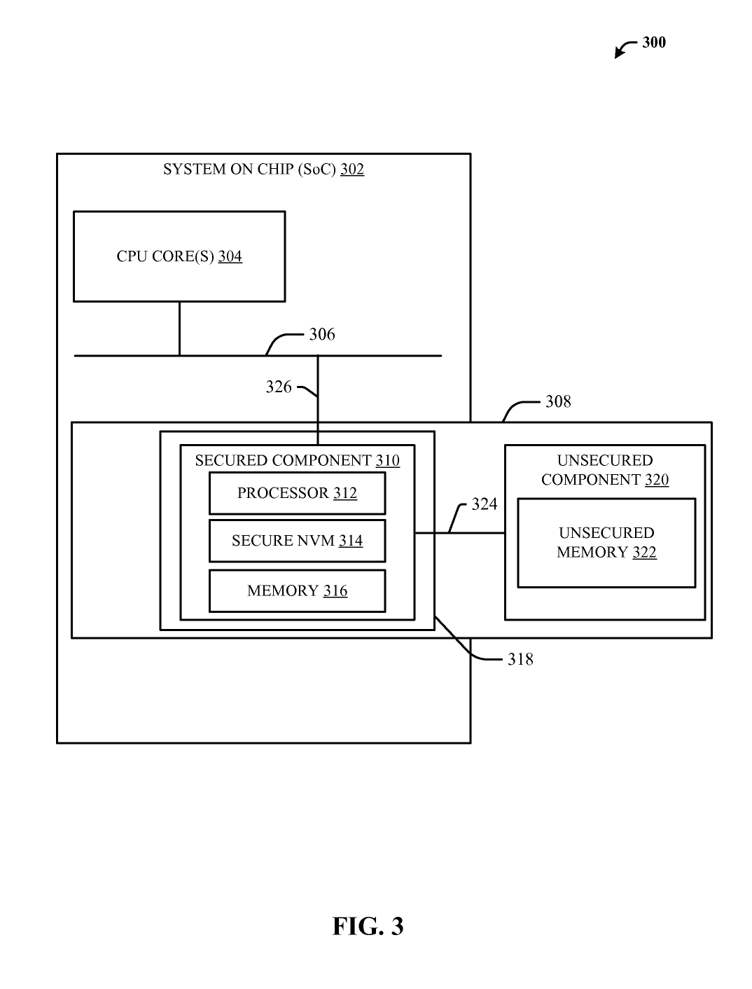

With reference to FIG. 3, a block diagram of a NFC system architecture 300 according to an aspect is illustrated. NFC system architecture 300 may include a SoC 302 that may be configured to enable processing for one or more CPU cores 304 through use of a shared bus 306. In an aspect, SoC 302 may represent mobile station modem (MSM) chip. In another aspect, SoC 302 may represent a NFC controller (NFCC).

NFC system architecture 300 further includes a SE 308. In an aspect, SE 308 may be a subscriber identification module (SIM) card, a secure digital (SD) card, a micro SD card, and/or an embedded SE 308. SE 308 may include a secured component 310 and an unsecured component 320. The secured component 310 and unsecured component may be coupled through interface 324. In an aspect, interface 324 may be configured to use a bus interface which supports encryption. In another aspect, interface 324 may be a standard high speed interface. In such an aspect, interface 324 provides for efficient loading of code, applets, etc., from unsecured memory 322 to the secured component 310 of the SE 308 for processing.

Secured component 310 may include a processor 312, secure NVM 314, and memory 316. In an aspect, processor 312 may be a dedicated processor 312 associated with the SE 308. In another aspect, processor 312 may be a processor available through SoC 302 with additional security protections (e.g., encryption, signatures, etc.) to assist in maintaining the security and integrity within SE 308. In an aspect, secure NVM 314 may include sufficient memory to store various items that may benefit from protection (e.g., root keys, certificates, etc.). In an aspect, memory 316 may include sufficient storage capability to allow for efficient loading and processing of information stored in unsecured memory 322.

Further, secured component 310 may be secured using a security shielding 318. In an aspect, security shielding 318 may provide various precautions against hardware and/or software attacks (e.g., differential power analysis (DPA), simple power analysis (SPA), laser attacks, voltage changes, temperature changes, laser probing, etc.). Security shielding 318 precautions may include but are not limited to metal layers to make observation of internal operation more difficult, light sensors which disable operation when the package is opened, multiple hardware paths for similar operations, etc. In an aspect, security shielding 318 may use existing metal layers associated with SoC 302 to implement digital or analog IP for forms of security shielding.

Unsecured component 320 may include unsecured memory 322. In an aspect, unsecured memory 322 may be specialized to the task of providing secure storage, standard NVM, RAM, any memory storage device, or any combination thereof In an aspect, unsecured memory 322 may be configured with approximately 1.2 Mbytes of space. In another aspect, unsecured memory 322 may be used to store code, applets, etc., associated with various functions that are accessible through SE 308. In such an aspect, unsecured memory 322 may be used for the non-volatile storage of applications (e.g., computer code) and data, and secure NVM 314 may be used to store a key system associated with the applications. In an aspect, to assist in maintaining the security and integrity of the code and data against attacks via the external interface, data may be encrypted (to secure) and signed (to guarantee integrity) whenever it leaves the SoC 302. As such, information in the unsecured memory 322 may be secure to the extent of the capability offered by the cryptographic operations used within the secured component 310.

In an operational aspect, a SE 308 may be certified as secure under guidelines known as the ‘Common Criteria’. These guidelines evaluate a Target of Evaluation (TOE) to be defined within which security is assessed. As depicted in FIG. 3, SE 308 including secured component 310 and unsecured component 320 may be evaluated as a TOE. In other words, in order to retain a TOE which may be reasonably similar to currently used TOEs, interfaces 326 between the secured component 310 and other components of the SoC 302 may be minimized In such an aspect, interfaces 326 may be configured to allow certain eFuse data to be available only to the SE 308. In another aspect, interfaces 326 may be cryptographically secured to internal (RAM) memory of the SoC 302, thus preventing observation of the operation of SE308 by other processors (e.g., CPU cores 304 in the SoC 302. In another aspect, secured component 310 may use a separated power domains and/or power management from other components (e.g., 304) on SoC 302. In still another aspect, secured component 310 may constrain interfaces with other processors (e.g., 304), for example, using a binary universal asynchronous receiver/transmitter (UART) interface.

Accordingly, a NFC system architecture 300 is presented in which various functions of SE 308 may be split into a secured component 310 which may be efficiently implemented in small silicon geometries on SoC 302 and a unsecured component 320 which may be more efficiently implemented on larger more costly geometries.

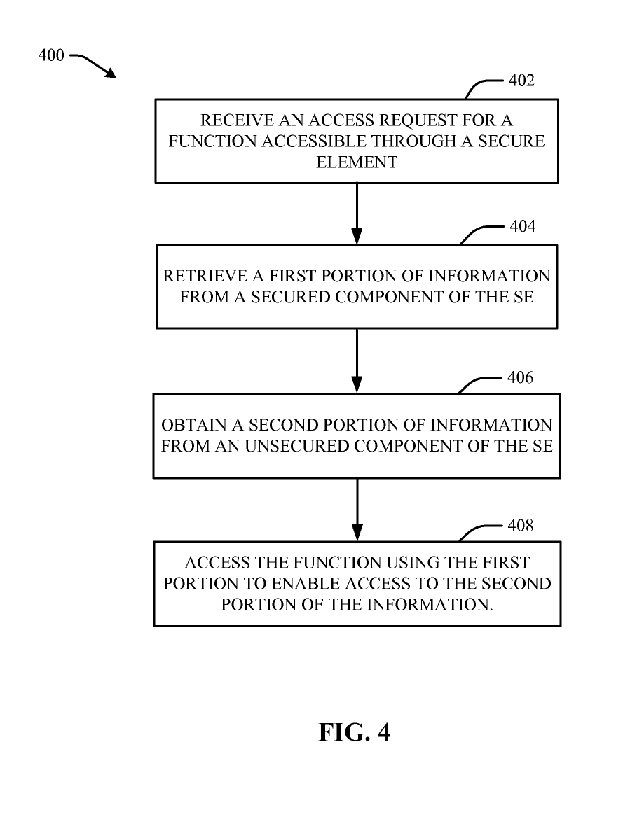

FIG. 4 illustrates various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 4, an example flowchart describing a process 400 for using a SE that is at least partially integrated with a SoC is illustrated. In an aspect, the process 400 may be performed by a communications device (e.g., communications device 500) that includes a SE (e.g., SE 560).

At block 402, a SE may receive a request to access a function (e.g., an application). In an aspect, the request may be received in response to activation of an application, measurements obtained from one or more sensors, in response to data received from another device, etc. In an aspect, the request may be received in response to activation of an application, measurements obtained from one or more sensors, data received from another device, etc. In an aspect, the request may be received through a cryptographically secure interface between the SE and the communications device.

At block 404, the SE may retrieve a portion of information associated with the function from a secured component of the SE. In an aspect, the information may include a key, a certificate, etc., associated with accessing the requested function in a secure manner. In another aspect, the secured component of the SE may be integrated into a SoC, such as but not limited to, a MSM chip, a NFCC, etc. In an aspect, a footprint of the SE on the SoC may be minimized by integrating only the secured component of the SE into the SoC. In another aspect, the secured component of the SE may have a geometry less than or equal to 65 nm.

At block 406, the SE may obtain a portion of information associated with the function from storage in an unsecured component of the SE. In an aspect, the unsecured component may include standard NVM that may store code, applets, etc., associated with various functions accessible through the SE. In another aspect, the retrieved portion of information may be communicated through a high speed interface to a secured component of the SE. In such an aspect, the retrieved portion may be placed in memory available in the secured component of the SE. In an aspect, the portion of the information that is stored in the unsecured component of the SE may be stored in an encrypted format based on the portion of the information that is stored in the secured component.

At block 408, the SE may facilitate access to the function based on the information obtained from the unsecured component of the SE and the information from the secured component of the SE. In an aspect in which the portion of the information that is stored in the unsecured component of the SE may be stored in an encrypted format, facilitating access may include decrypting the information.

Therefore, process 400 provides a method for using a SE that is at least partially integrated into a SoC.

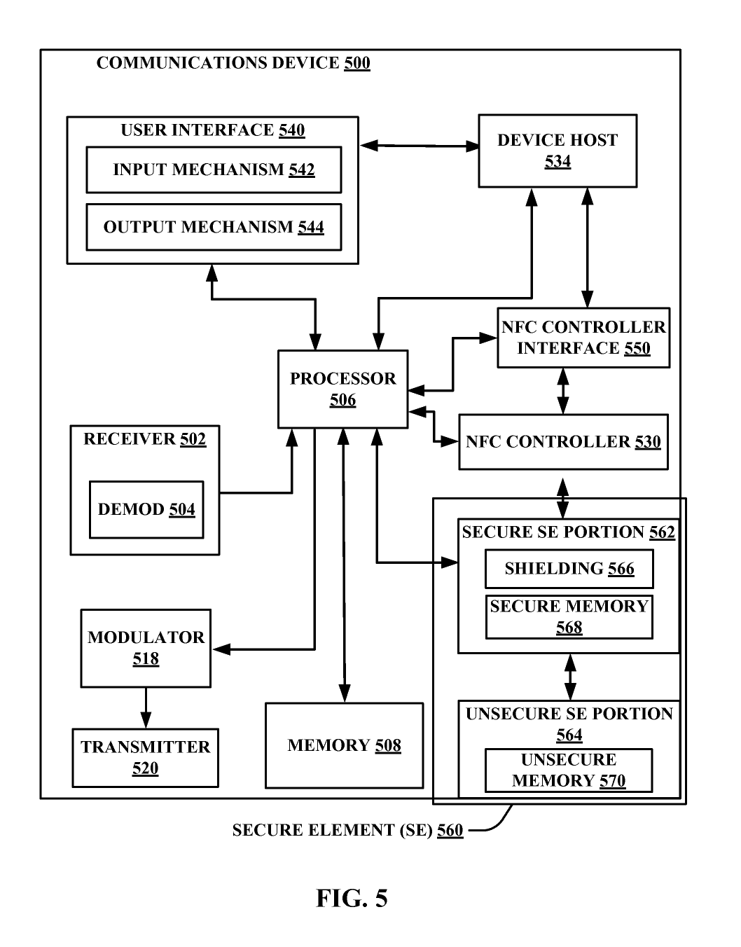

While referencing FIG. 3, but turning also now to FIG. 5, an example architecture of communications device 500 is illustrated. As depicted in FIG. 5, communications device 500 comprises receiver 502 that receives a signal from, for instance, a receive antenna (not shown), performs typical actions on (e.g., filters, amplifies, downconverts, etc.) the received signal, and digitizes the conditioned signal to obtain samples. Receiver 502 can comprise a demodulator 504 that can demodulate received symbols and provide them to processor 506 for channel estimation. Processor 506 can be a processor dedicated to analyzing information received by receiver 502 and/or generating information for transmission by transmitter 520, a processor that controls one or more components of communications device 500, and/or a processor that both analyzes information received by receiver 502, generates information for transmission by transmitter 520, and controls one or more components of communications device 500. Further, signals may be prepared for transmission by transmitter 520 through modulator 518 which may modulate the signals processed by processor 506.

Communications device 500 can additionally comprise memory 508 that is operatively coupled to processor 506 and that can store data to be transmitted, received data, information related to available channels, TCP flows, data associated with analyzed signal and/or interference strength, information related to an assigned channel, power, rate, or the like, and any other suitable information for estimating a channel and communicating via the channel. Further, processor 506 and/or device host 534 that can be configured to assist in control of an NFC system.

In an aspect, processor 506, NFCC 530, and/or SE 560 may provide means for receiving a request to access a function that is accessible through information stored in the SE 560, means for retrieving a first portion of the information associated with the function that is stored in a secured component 562 of the SE 560, means for obtaining a second portion of the information associated with the function that is stored in an unsecured component 564 of the SE 560, and means for facilitating access to the function using the first retrieved portion of the information to enable access to the second obtained portion of the information. In an aspect, the SE 560 may include a processor 506, RAM, and NVM. In an aspect, the secured component 562 may include the processor and the RAM. In an aspect, the unsecured component 564 may include substantially all of the NVM.

It will be appreciated that data store (e.g., memory 508) described herein can be either volatile memory or NVM, or can include both volatile and NVM. By way of illustration, and not limitation, NVM can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 508 of the subject systems and methods may comprise, without being limited to, these and any other suitable types of memory.

In another aspect, communications device 500 may include NFC controller interface (NCI) 550. In one aspect, NCI 550 may be operable to enable communications between a NFC enabled antenna (e.g., 502, 520) and NFC controller 530. NCI 550 may be configurable to function in a listening mode and/or a polling mode.

In another aspect, communications device 500 may include one or more secure elements 560. In one aspect, the one or more secure elements 560 may be coupled to and/or at least partially integrated within NFC controller 530. In one aspect, the one or more secure elements 560 may be coupled to and/or at least partially integrated within a MSM chip (e.g., processor 506). In one aspect, the one or more secure elements 560 may be secure elements or near field controller execution environments (NFCEEs). In one aspect, the one or more secure elements 560 may include a UICC with various modules such as but not limited to, a SIM, a CSIM, etc. In another aspect, the one or more secure elements 560 may be configured to perform the processes described in FIG. 4.

SE 560 may include a secured component 562 and an unsecured component 564. The secured component 562 and unsecured component may be coupled through an interface. In an aspect, the interface may be configured to use a bus interface which supports encryption. In another aspect, the interface may be a standard high speed interface. In such an aspect, the interface provides for efficient loading of code, applets, etc., from unsecured memory 322 to the secured component 562 of the SE 560 for processing.

Secured component 562 may include secure memory 568. In an aspect, secure memory 568 may include sufficient memory to store various items that may benefit from protection (e.g., root keys, certificates, etc.). In an aspect, secure memory 568 may include 5 to 10 kbits of space. In an aspect, secure memory 568 may include sufficient storage capability to allow for efficient loading and processing of information stored in unsecured memory 564.

Further, secured component 562 may be secured using a security shielding 566. In an aspect, security shielding 566 may various precautions against hardware-based attacks, such as but not limited to metal layers to make observation of internal operation more difficult, light sensors which disable operation when the package is opened, multiple hardware paths for similar operations, etc. In an aspect, security shielding 566 may use existing metal layers associated with the SoC to implement digital or analog IP for forms of security shielding.

Unsecured component 564 may include unsecured memory 570. In an aspect, unsecured memory 570 may be specialized to the task of providing secure storage, standard NVM, or any combination thereof In an aspect, unsecured memory 570 may be configured with approximately 1.2 Mbytes of space. In another aspect, unsecured memory 570 may be used to store code, applets, etc., associated with various functions that are accessible through SE 560. In such an aspect, unsecured memory 570 may be used for the non-volatile storage of applications (e.g., computer code) and data, and secure memory 568 may be used to store a key system associated with the applications. In an aspect, to assist in maintaining the security and integrity of the code and data against attacks via the external interface, data may be encrypted (to secure) and signed (to guarantee integrity) whenever it leaves the SE 560. As such, information in the unsecured memory 570 may be secure to the extent of the capability offered by the cryptographic operations used within the secured component 562.

Additionally, communications device 500 may include user interface 540. User interface 540 may include input mechanisms 542 for generating inputs into communications device 500, and output mechanism 544 for generating information for consumption by the user of the communications device 500. For example, input mechanisms 542 may include a mechanism such as a key or keyboard, a mouse, a touch-screen display, a microphone, etc. Further, for example, output mechanism 544 may include a display, an audio speaker, a haptic feedback mechanism, a Personal Area Network (PAN) transceiver etc. In the illustrated aspects, the output mechanism 544 may include a display operable to present media content that is in image or video format or an audio speaker to present media content that is in an audio format.

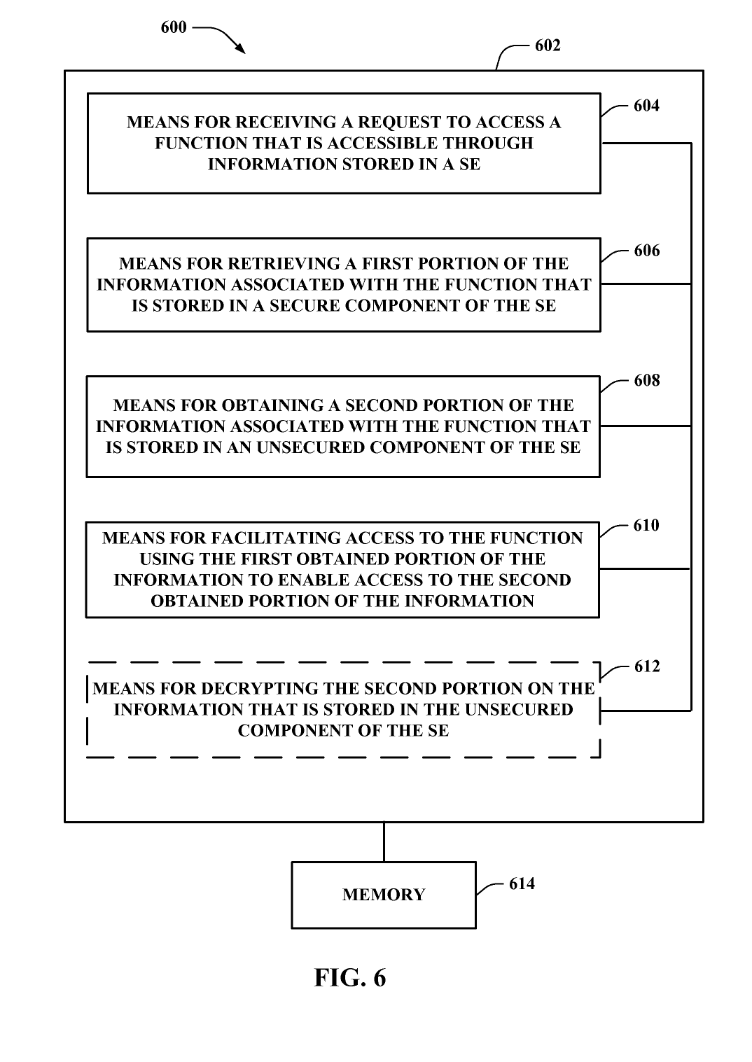

FIG. 6 depicts a block diagram of an example communication system 600 operable to facilitate efficient functionality with a SE 308 that may be at least partially integrated into a communications device. For example, communication system 600 can reside at least partially within a communications device (e.g., communications device 500). Further, SE 308 may reside at least partially within the communications device (e.g., communications device 500). It is to be appreciated that system 600 is represented as including functional blocks, which can be functional blocks that represent functions implemented by a processor, software, or combination thereof (e.g., firmware). System 600 includes a logical grouping 602 of electrical components that can act in conjunction.

For instance, logical grouping 602 can include an electrical component that may provide means for receiving a request to access a function that is accessible through information stored in the SE. For example, the means for receiving can include secured component 310 and processor 312 of SE 308, and/or processor 506 of communications device 500.

Further, logical grouping 602 can include an electrical component that may provide means for retrieving a first portion of the information associated with the function that is stored in a secured component of the SE 606. In an aspect, the secured component may include the processor and RAM. For example, the means for retrieving 606 can include secured component 310, secure NVM 314, and/or processor 312 of SE 308.

Further, logical grouping 602 can include an electrical component that may provide means for obtaining a second portion of the information associated with the function that is stored in an unsecured component of the SE 608. In an aspect, the unsecured component may include substantially all of the NVM. For example, the means for obtaining 608 can include secured component 310, unsecured component 320, secure NVM 314, unsecured memory 322, and/or processor 312 of SE 308. In an aspect, the means for obtaining 608 may be configured to use a high speed interface between the unsecured component of the SE and the secured component of the SE.

Moreover, logical grouping 602 can include an electrical component that may provide means for facilitating access to the function using the first retrieved portion of the information to enable access to the second obtained portion of the information 610. In an aspect, the means for facilitating access 610 can include secured component 310, unsecured component 320, secure NVM 314, unsecured memory 322, and/or processor 312 of SE 308.

In an optional aspect, logical grouping 602 can include an electrical component that may provide means for decrypting information associated with a function 612. For example, the means for decrypting 612 can include secured component 310 and/or processor 312 of SE 308.

Additionally, system 600 can include a memory 614 that retains instructions for executing functions associated with the electrical components 604, 606, 608, 610, and 612, and stores data used or obtained by the electrical components 604, 606, 608, 610, 612, etc. In an aspect, memory 614 can include memory 508 and/or can be included in memory 508. While shown as being external to memory 614, it is to be understood that one or more of the electrical components 604, 606, 608, 610, and 612 may exist within memory 614. In one example, electrical components 604, 604, 606, 608, 610, and 612 can include at least one processor, or each electrical component 604, 604, 606, 608, 610, and 612 can be a corresponding module of at least one processor. Moreover, in an additional or alternative example, electrical components 604, 606, 608, 610, and 612 may be a computer program product including a computer readable medium, where each electrical component 604, 606, 608, 610, and 612 may be corresponding code.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, mobile equipment (ME), remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, near-field communications (NFC-A, NFC-B, NFC-F, etc.), and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed:

1. An apparatus for communications, comprising:
a secure element (SE) comprises a processor, random access memory (RAM), and non-volatile memory (NVM), wherein the SE further comprises a secured component of the SE, an unsecured component of the SE, wherein the unsecured component and the secured component are coupled through an interface, and wherein the SE is configure to:
receive a request to access a function that is accessible through information stored in the SE;
retrieve a first portion of the information associated with the function that is stored in the secured component of the SE, wherein the secured component comprises the processor and the RAM;
obtain a second portion of the information associated with the function that is stored in the unsecured component of the SE, wherein the unsecured component comprises substantially all of the NVM; and
facilitate access to the function using the first retrieved portion of the information to enable access to the second obtained portion of the information.

2. The apparatus of claim 1, wherein the function is an application stored on a communications device, and wherein the request is received through a cryptographically secure interface between the SE and the communications device.

3. The apparatus of claim 1, wherein the NVM included in the unsecured component of the SE comprises standard NVM.

4. The apparatus of claim 1, wherein the secured component of the SE is secured using a security shielding.

5. The apparatus of claim 1, wherein the secured component of the SE is integrated into a system on chip (SoC).

6. The apparatus of claim 5, wherein the SoC is a near field communication controller (NFCC).

7. The apparatus of claim 5, wherein the SoC is a mobile station modem (MSM) chip.

8. The apparatus of claim 5, wherein a footprint of the SE on the SoC is minimized by integrating only the secured component of the SE into the SoC.

9. The apparatus of claim 8, wherein the secured component of the SE has a geometry less than or equal to 65 nm.

10. The apparatus of claim 5, wherein a security shielding for the secured component includes one or more existing metal layers associated with the SoC.

11. The apparatus of claim 1, wherein the SE is further configured to use a high speed interface between the unsecured component of the SE and the secured component of the SE.

12. The apparatus of claim 1, wherein the second portion of the information associated with the function that is stored in the unsecured component of the SE is stored in an encrypted format based on the first portion of the information associated with the function that is stored in the secured component.

13. The apparatus of claim 12, wherein the SE is further configured to decrypt the second portion of the information using the processor included in the secured component of the SE, based on one or more ciphers included in the first portion of the information.

14. A method of communication using a secure element (SE), comprising:
receiving a request to access a function that is accessible through information stored in the SE, wherein the SE comprises a processor, random access memory (RAM), and non-volatile memory (NVM);
retrieving a first portion of the information associated with the function that is stored in a secured component of the SE, wherein the secured component comprises the processor and the RAM;
obtaining a second portion of the information associated with the function that is stored in an unsecured component of the SE, wherein the unsecured component comprises substantially all of the NVM; and
facilitating access to the function using the first retrieved portion of the information to enable access to the second obtained portion of the information.

15. The method of claim 14, wherein the function is an application stored on a communications device, and wherein the request is received through a cryptographically secure interface between the SE and the communications device.

16. The method of claim 14, wherein the NVM included in the unsecured component of the SE comprises standard NVM.

17. The method of claim 14, wherein the secured component of the SE is secured using a security shielding.

18. The method of claim 14, wherein the secured component of the SE is integrated into a system on chip (SoC).

19. The method of claim 18, wherein the SoC is a near field communication controller (NFCC).

20. The method of claim 18, wherein the SoC is a mobile station modem (MSM) chip.

21. The method of claim 18, wherein a footprint of the SE on the SoC is minimized by integrating only the secured component of the SE into the SoC.

22. The method of claim 21, wherein the secured component of the SE has a geometry less than or equal to 65 nm.

23. The method of claim 18, wherein a security shielding for the secured component includes one or more existing metal layers associated with the SoC.

24. The method of claim 14, wherein the obtaining comprises using a high speed interface between the unsecured component of the SE and the secured component of the SE.

25. The method of claim 14, wherein the second portion of the information associated with the function that is stored in the unsecured component of the SE is stored in an encrypted format based on the first portion of the information associated with the function that is stored in the secured component.

26. The method of claim 25, wherein the accessing further comprises decrypting the second portion of the information, by the processor included in the secured component of the SE, based on one or more ciphers included in the first portion of the information.

27. An apparatus for communications, comprising:
means for receiving a request to access a function that is accessible through information stored in a secure element (SE), wherein the SE comprises a processor, random access memory (RAM), and non-volatile memory (NVM);
means for retrieving a first portion of the information associated with the function that is stored in a secured component of the SE, wherein the secured component comprises the processor and the RAM;
means for obtaining a second portion of the information associated with the function that is stored in an unsecured component of the SE, wherein the unsecured component comprises substantially all of the NVM; and
means for facilitating access to the function using the first retrieved portion of the information to enable access to the second obtained portion of the information.

28. The apparatus of claim 27, wherein the function is an application stored on a communications device, and wherein the request is received through a cryptographically secure interface between the SE and the communications device.

29. The apparatus of claim 27, wherein the NVM included in the unsecured component of the SE comprises standard NVM.

30. The apparatus of claim 27, wherein the secured component of the SE is secured using a security shielding.

31. The apparatus of claim 27, wherein the secured component of the SE is integrated into a system on chip (SoC).

32. The apparatus of claim 31, wherein the SoC is a near field communication controller (NFCC).

33. The apparatus of claim 31, wherein the SoC is a mobile station modem (MSM) chip.

34. The apparatus of claim 31, wherein a footprint of the SE on the SoC is minimized by integrating only the secured component of the SE into the SoC.

35. The apparatus of claim 34, wherein the secured component of the SE has a geometry less than or equal to 65 nm.

36. The apparatus of claim 31, wherein a security shielding for the secured component includes one or more existing metal layers associated with the SoC.

37. The apparatus of claim 36, wherein the means for obtaining are further configured to use a high speed interface between the unsecured component of the SE and the secured component of the SE.

38. The apparatus of claim 27, wherein the second portion of the information associated with the function that is stored in the unsecured component of the SE is stored in an encrypted format based on the first portion of the information associated with the function that is stored in the secured component.

39. The apparatus of claim 38, wherein the means for facilitating access are further configured to decrypt the second portion of the information, based on one or more ciphers included in the first portion of the information.

40. A computer program product, comprising:
a computer-readable medium comprising code for:
receiving a request to access a function that is accessible through information stored in the SE, wherein the SE comprises a processor, random access memory (RAM), and non-volatile memory (NVM);
retrieving a first portion of the information associated with the function that is stored in a secured component of the SE, wherein the secured component comprises the processor and the RAM;
obtaining a second portion of the information associated with the function that is stored in an unsecured component of the SE, wherein the unsecured component comprises substantially all of the NVM; and
facilitating access to the function using the first retrieved portion of the information to enable access to the second obtained portion of the information.
